(19) United States
(12) Patent Application Publication
(10) Pub. No.: US 2019/0001732 A1
(43) Pub. Date: Jan. 3, 2019

(54) Method and System for Reusable Printed Card

(71) Applicant: Harry Ongsitco, Northridge, CA (US)

(72) Inventor: Harry Ongsitco, Northridge, CA (US)

(21) Appl. No.: 16/013,348

(22) Filed: Jun. 20, 2018

Related U.S. Application Data
(60) Provisional application No. 62/526,938, filed on Jun. 29, 2017.

(51) Int. Cl. B42D 15/04; B42D 15/02; B42D 25/305; G06K 19/07

(52) U.S. Cl. CPC B42D 15/045; B42D 15/027; B42D 25/285; G06K 19/0727; G06K 19/0725; B42D 25/305

(57) ABSTRACT

The reusable printed card is a physical card such as a greeting card, postcard or business card, with an embedded RFID chip, specifically NFC (Near Field Communication), and a QR (Quick Response) Code, wherein the contents, such as text messages, photos, and audio-visual contents composed or arranged by the sender can be read and then be modified, to reuse it, eventually by the recipient using one's personal NFC-enabled device such as smartphone, or tablet. The computer application residing on the central server identifies the content and card information via the NFC or QR Code that is transmitted via the recipient's personal device through the internet, then simulating the printed card and displaying the actual contents on the personal device upon scanning the card. The history of the contents of each card is kept and are readily available for the sender's and recipients' memory-sake and for social media purposes under the sender's and recipient's account stored on the central server, and/or in their personal devices' local storage in the case of business card information for instance.

### CROSS-REFERENCE TO RELATED APPLICATION

This application claims priority to an earlier filed U.S. provisional patent application, U.S. provisional patent application No. 62/526,938, EFS ID 29657079, which was filed on Jun. 29, 2017, and is incorporated herein by reference

### FIELD OF THE INVENTION

This invention relates to a method and system wherein a printed card such as a greeting card, a postcard or a business card can be reused by the readers or the recipients of the printed card for the same purpose but with a new or revised content. Particularly, this invention relates to the method and system to re-use a written or printed material, such as greeting cards or business cards, by allowing a way to re-write its current content while saving the previous content on a cloud or media for memory-keeping. More particularly, the invention relates to a method and system for making the composer of the printed card to let the readers or the recipients of the printed card revise the content such as but not limited to the writings, diagrams, photos, images, illustrations, and the like on it so that the recipient can re-send the same material to another recipient with new or revised contents. Specifically, the invention relates to a novel technique of communicating via tangible reading material (printed card) wherein the written or drawn contents are digitally composed by the writer using the system that is hosted on the Central Server connected to World Wide Web (internet), and stored on the cloud or database, while the printed card, such as greeting cards, having an embedded RFID, NFC (Near Field Communication) in particular, that refers to a specific content on the server via a system-assigned unique content ID, that can be read and viewed, revised, edited, or changed by the recipients using their own personal device such as Smart Phone by connecting the readers as well to the Central Server connected to world wide web, upon identifying the material using NFC, QR code or ID code, allowing the readers to be able to re-send the same specific printed material to other recipient with new or revised contents. The invention also further relates to the method of keeping the tradition of sending tangible printed card such as greeting cards, as opposed to just e-mailing or texting a digital content, wherein both processes are combined here, in addition to the recipient being able to erase, add, or edit the contents for re-sending purposes so as to limit the impact on the environment in reproducing printed cards.

### BACKGROUND OF THE INVENTION

Conventional printed material, such as greeting card, cannot be reused by the readers and thus they are not environment-friendly unless the materials are recycled by the recycling companies. Once recycled though, the material may have a different form and purpose now than the original. Among the many printed cards, there are over 7 billion of greeting cards alone, and in the U.S.A. alone that are mailed or handed out each year. Although electronic greetings via email or social media makes the greetings earth-friendly, they however, do not replace the excitement of a centuries-old tradition of sending a tangible materials. Thus, allowing the recipient to revise the content of the printed card and be able to attach physically or digitally other things such as pictures, gift cards and the like, make the material re-usable while still keeping the tradition.

While there are re-usable greeting cards out there, the method does not really have a greater impact on the environment, because it only saves the design of the card itself since the reader still needs to insert a new paper to write on it. Likewise, this method is not appealing to the younger generations and thus, has minimal effect on saving the environment since only few utilize them.

While there are rewritable media such as CD, DVD and Cassette tape, the material on this invention, however is in a form of printed materials, such as but not limited to greeting cards and business card that do not make use of those media readers such as CD reader, DVD reader, tape reader, SD card reader, etcetera. It only makes use of NFC chip to identify the content when connecting to the main server.

While there are already greeting and informational media with NFC, QR code or ID code to read the material via the reader's smart phone, the existing system, however, does not offer the readers to revise the content of it and be able to resend it, for it is not invented to have an impact on the environment but merely to have the ability to add video, music, photos and alike to the reading material via the NFC-enabled device.

For other prints, such as business cards, newsletters, brochures, and the like, the inventor is not aware of such products out there that are re-usable to the readers or recipients of the printed card.

Some of the existing materials out there can be fully or partially read or viewed on the same manner but are not re-usable and not in the purpose of mailing as printed material such as greeting-cards. For reading paper materials, besides being reusable, this invention, also, makes the printed card time-triggered, that is, it can be set to when or when not the content can be revised and for the item to be resent. Composer or sender or reader of the contents can set specific time or duration, lock or unlock it, activate or inactivate it, before others can revise it. Likewise, there is an option for the senders or readers to auto-post it on their own social media such but not limited to Facebook, Twitter, Instagram and Google. Senders can also attach digital contents such as but not limited to photos and videos. They can also attach gifts digitally such as money or gift-cards via the retail stores existing digital gift-card such as but not limited to Amazon or Walmart.

It is an object of the present invention for communicating using traditional reading material with an impact on saving the environment by providing a method and a system, which comprises of a tangible message or informational material with NFC, QR code and/or ID code, and for the web-based computer programming logical system, to be described here, will manage it via the Central Server, and wherein the readers are required to have personal NFC-enabled device to read it such as a smart phone, PDA, a tablet, laptop, desktop or something similar where the device can connect to the Central Server using the app or browser via the internet. It is also an object of the present invention to provide a method and a system for communicating among each other in such a way that the readers can re-use the materials received by revising its contents and resending it to other recipients with a new or revised content. Another object of this invention is to retain the most admired tradition of sending tangible communication material over just pure electronic communication in a practical manner while limiting the impact on the environment. A specific object of the invention is to provide an environmentally attractive system and method of traditional way of greeting and communicating wherein the memories or information are kept on the clouds to be cherished or referred to anytime, while the same material to relay the message is re-used over and over. A further object of the present invention is to provide a technique that other sectors or industries can follow, allowing their media products or printed cards to be identified to the Central Server, making their materials reusable after certain time without the need to physically recycle the composition of the printed card. Still a further object of the present invention is to provide a system for communicating that is exciting to write and/or read, manifesting an effort on the side of the sender, and an advantage for those sending it for marketing purposes. These and other objects of the invention will be apparent to those skilled in the art from the description that follows.

### BRIEF SUMMARY OF THE INVENTION

In the real world, the method and the system of this invention center around the printed card, and the innovative programming system residing on the Central Server that manages the content of the printed card. It, generally, comprises of printed card such as but not limited to a greeting card with embedded NFC chip and/or QR code and the Application system which provides the solution to manage the contents of the reusable prints. So in summary, the invention relates to a novel technique of communicating via tangible printed card wherein the written or drawn contents are digitally composed or stored by the writer using the system hosted on the Central Server accessible via the internet, and the data is stored on the cloud or media, while the printed card, such as the paper greeting cards, has embedded RFID, NFC (Near Field Communication) in particular, that refers to the specific content in the specific Central Server via the server address or URL and the content ID stored on the server's database, that can be read, viewed, changed, deleted, saved, auto-posted on social media by the recipients using their own personal device such as his/her Smart Phone by connecting it to the server as well, via the internet through the app or website, upon tapping, scanning the QR code or entering the ID on the material, allowing the readers or others to resend the same material with new or revised contents. Such method and system will keep the centuries-old tradition of sending tangible item compare to just sending an electronic greetings or information, while limiting the impact on the environment since the card can be reused.

### BRIEF DESCRIPTION OF THE DRAWINGS

A clear understanding of the key features of the invention summarized above may be referenced to the appended drawings, which illustrate the method and system of the invention. Although it will be understood that such drawings depict preferred embodiments of the invention and, therefore, are not to be considered as limiting its scope with regard to other embodiments which the invention is capable of contemplating. Accordingly:

FIG. 1 is a front-view of the inside of greeting card illustrating the composition of the method and system of this invention showing the major components of the greeting card to make it reusable for the process.

FIG. 2 is a top-view of a printed card illustrating the composition of the method and system of this invention showing the major components of the printed card, such as a business card, to make it reusable for the process.

FIG. 3 is an illustration of the method and system of this invention showing components of the process.

FIG. 4 is an illustration of the method and system of this invention showing an overview of the series of events that would take place in making the printed card reusable.

FIG. 5 is a system diagram illustrating the method and system showing how the sending or reading process of the printed card will be initiated trough the actual printed card.

FIG. 6 is a system diagram illustrating the method and system showing how the sending or reading process will be initiated through the website or application.

FIG. 7 is a diagram of the method and system of this invention illustrating the series of events that would take place when the writer/composer/sender of the printed material initiated SEND process as shown in FIG. 6.

FIG. 8 is a diagram of the method and system of this invention illustrating the series of events that would take place when the reader/recipient of the printed material initiated a READ process as shown in FIG. 6.

### DETAILED DESCRIPTION OF THE INVENTION

Referring now to the invention in more detail, shown in FIG. 1 is an illustration of a greeting card 10 which can be of any size, shape and design. The said greeting card comprises of an NFC device 11 embedded in the card wherein it stores the card ID information, a printed unique QR code 12, and/or a printed unique ID 13, wherein each of the said three components will identify the specific greeting card by the Central Server that will be explained later.

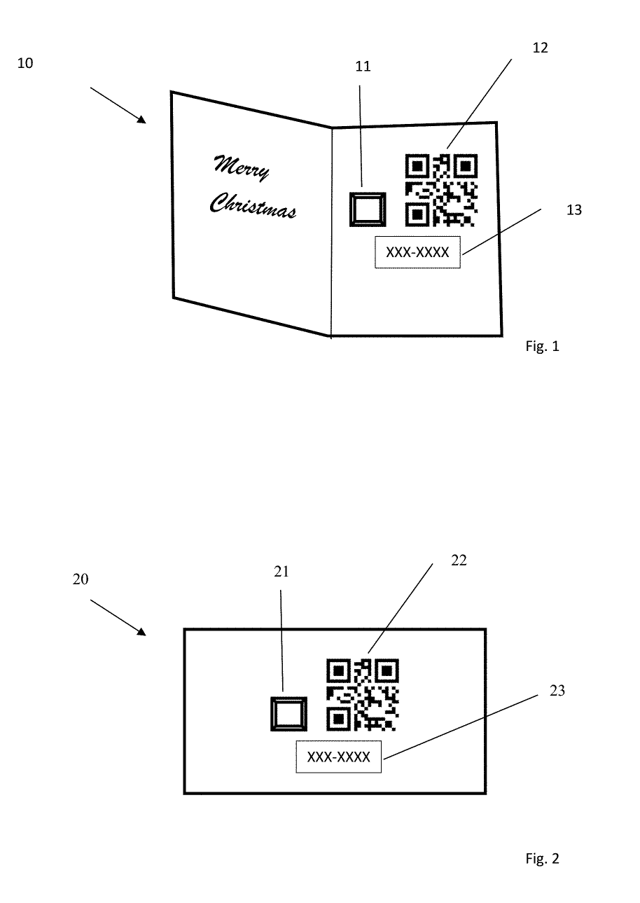

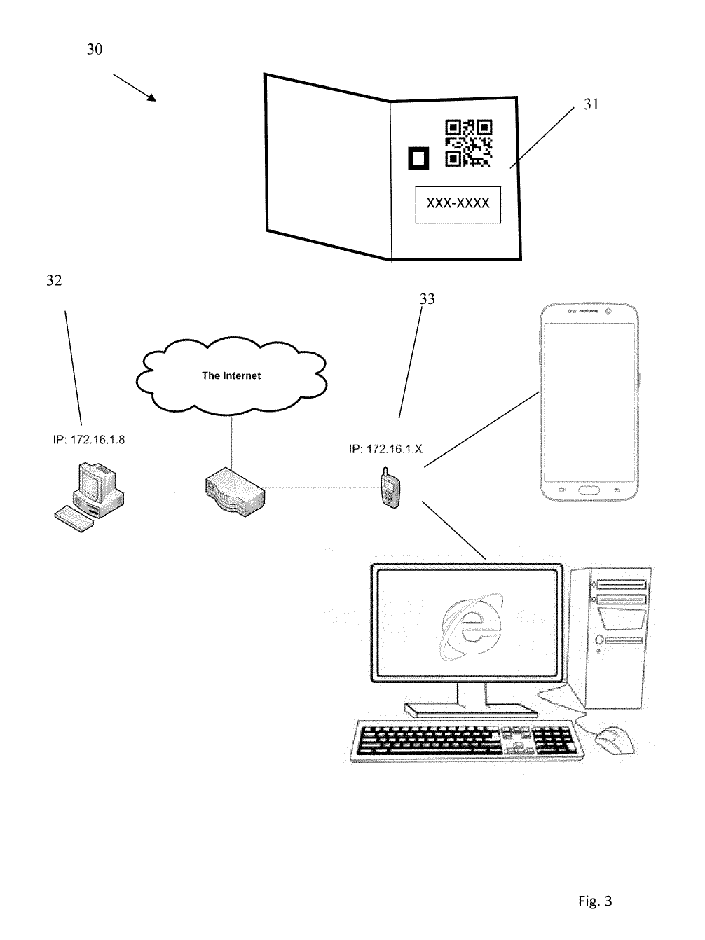

FIG. 2, similar to FIG. 1, is just to illustrate that the same process can be used to any other printed material 20, other than greeting card, while having the same three components described above, which are NFC device 21 wherein it stores the card ID information, a printed unique QR code 22, and/or a printed unique ID 23, wherein each of the said three components will identify the specific printed card by the Central Server (FIG. 3, 33) that will process the reusable prints.

And so, referring now to FIG. 3, the construction details of the invention is that the specific printed card 31, can be identified by the Central Server 32 which processes the content of the printed card, via the sender's or recipient's personal device 33, that is connected to the internet, such as but not limited to smart phone, tablet, laptop, or desktop. The way the printed card is identified by the sender's or reader's personal device is either by tapping the card for those devices that have an NFC reader, or by scanning the QR via the device's built-in camera or installed QR app, or by entering the ID, through the website using the device browser or the installed specific application on the device responsible for communicating to the application on the Central Server.

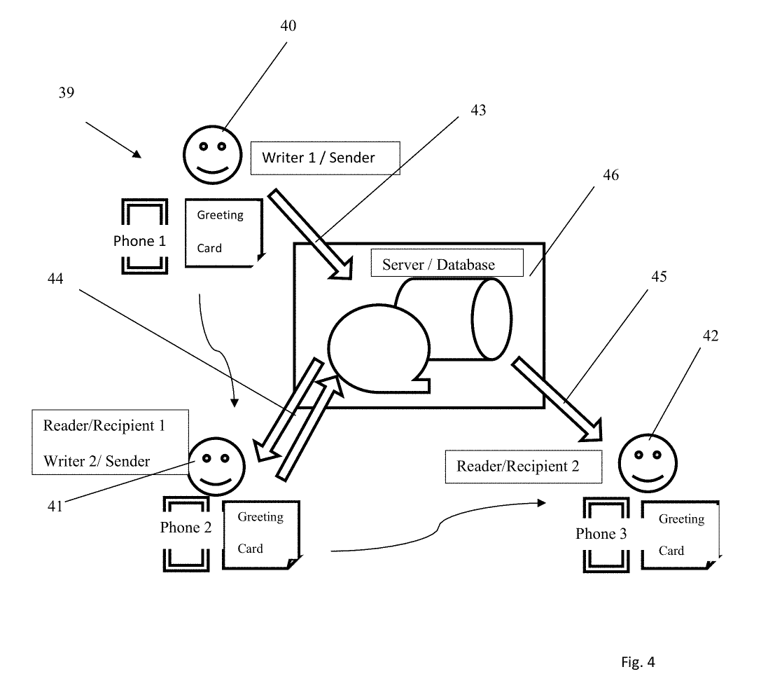

Systematically, FIG. 4 relates to an overview of series of events that will take place in the real world 39 to portray a reusable greeting card. As illustrated, the first writer of the printed card 40, for instance, is intending to send it to the first recipient 41, who in turns, is a second writer as he intends to revise the content of the card and send it to second recipient 42. The first writer's action, represented by the arrow 43, shows the direction is towards the Central Server 46. This indicates that the writer is entering information and storing it to the database 47 in the said server. While the first recipient's action is represented by two arrow 44, since the first recipient is reading the content, as well as re-writing the content so that he can send it to the second recipient making the greeting card reusable. The second recipient's action is represented by single arrow 45, as he is just retrieving the information that is revised by the first recipient.

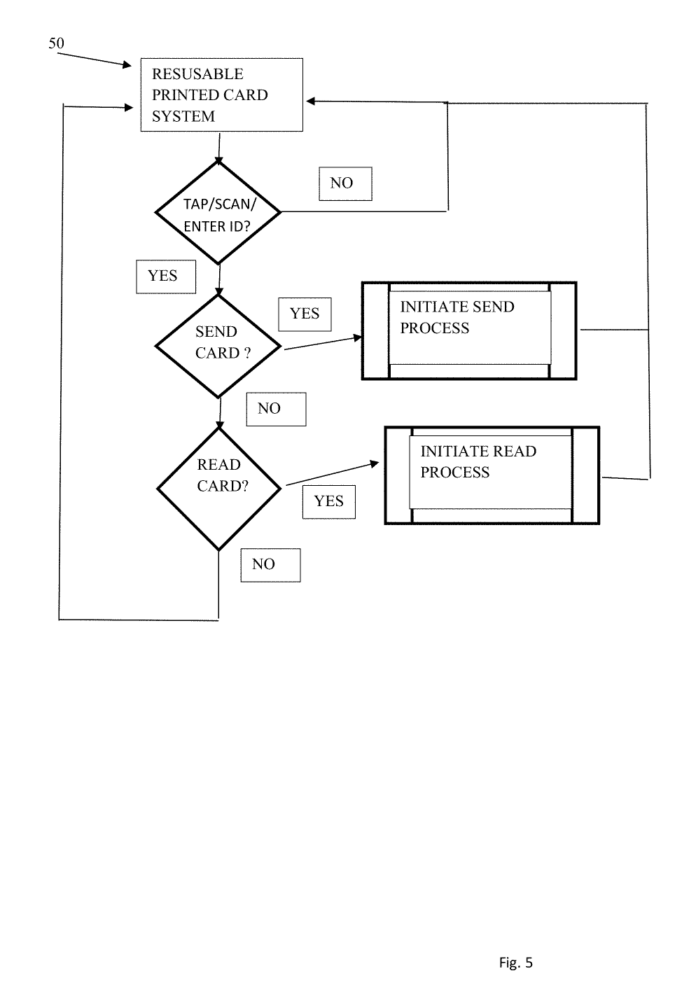

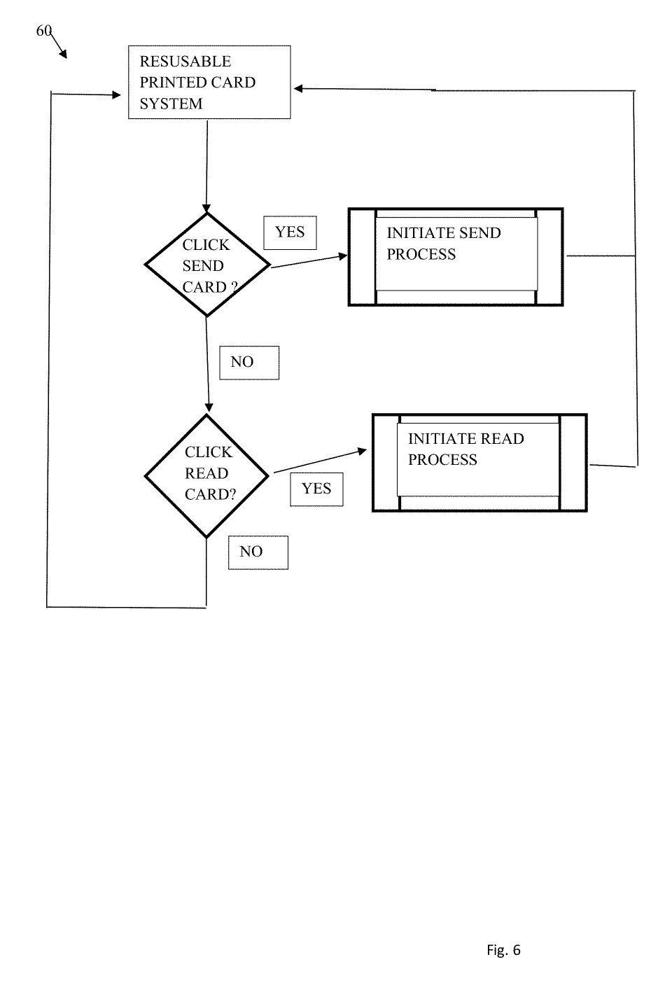

Referring now to FIG. 5, wherein the overview of the system and method of the present invention as managed by the computer application on the Central Server are shown in flow-diagram 50. This diagram shows the two major processes that is triggered by an action of the user of personal device, herein can be referred to as the client, shown on the previous illustration, which are SEND and READ actions. These actions can be initiated by the client by first identifying the printed card by tapping it for the device that is NFC-capable, scanning the QR Code or entering the Card ID. Similarly, FIG. 6 only shows another way 60 the actions are initiated by the clients, which is by going to the website or the device application, and manually selecting SEND or READ action. Either way, it will initiate a specific action and will require to identify the card to be read or revised, which is previously described, via the NFC, QR code or Card ID.

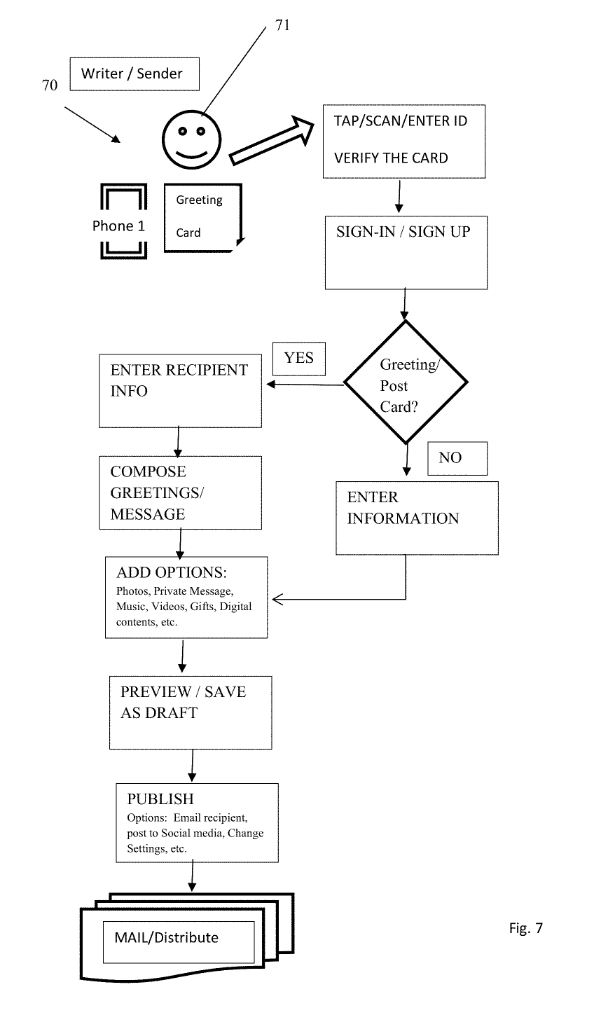

The SEND action in FIG. 6 is further elaborated on FIG. 7. The writer/sender of the card 70 is ready to scan the greeting card with his smart phone device. Depending on the smart phone, he can be auto directed to the Central Server via the internet. Note that some smart phone or device is not capable of auto-direction and thus would either manually go to the website of the Central Server via the device browser or install the application to his device. Either way, the system will require the sender to sign-in, if he is not signed-in yet, or sign-up if he has not signed-up yet. Signing up can be done via major social media such as but not limited to Facebook or Google Plus. If the Sender has no physical printed card on hand, he will be directed to the ORDER Process, to order a card based on occasions if he's ordering a greeting card, or based on use if some other types of printed cards such as a business card.

If the printed card is greeting card, the system will accept Recipient Information and allow to compose the greetings and messages. Otherwise, the system will accept the informational content of the card. Since the invention is the system and method of reusable printed card, options regarding the programs/applications/software to implement the method are variable and can be added or subtracted, be made required or optional, depending on the desired settings the senders or readers set such as but not limited to digital content, front-end setting, privacy settings, and related functions and procedures. The printed card, once saved, can be shipped directly to the recipients or to the sender first.

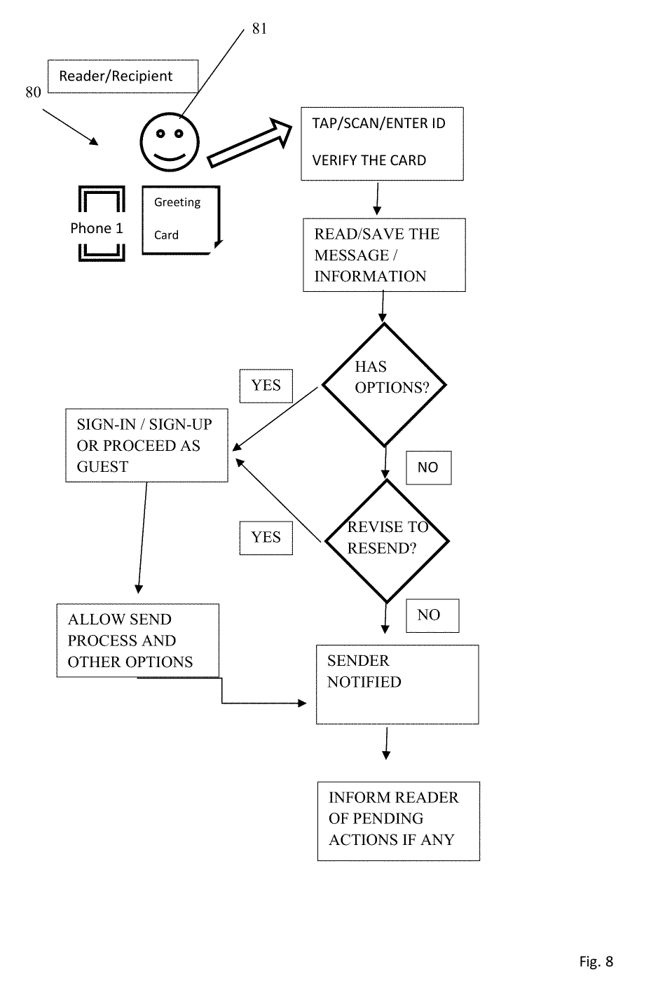

Similarly, the READ action in FIG. 6 is further elaborated on FIG. 8. The reader/recipient of the card 80 can read the printed card by the same method, which is either via NFC, QR code or Card ID. Depending on the smart phone, he can be auto directed to the Central Server via the internet. Note that some smart phone or device is not capable of auto-direction and thus would either manually go to the website of the Central Server via the device browser or install the application to his device. Either way, the system will display the card and the messages together with some other optional digital contents such as but no limited to photos, video, music, gifts, and animations. Depending on the privacy set by the sender, some contents will require the reader to sign-in, if he is not signed-in yet, or sign-up if he has not signed-up yet, to view those contents. Signing up can be done via major social media such as but not limited to Facebook or Google Plus. After viewing it, the Reader has the option to revise the content so that the printed card can be reused and be resent to someone else. Original contents are saved on the server or locally for memory-keeping. If the printed card is business card, original information will be saved on the contacts of the recipient.

Since the invention is the system and method of reusable printed card, options regarding the programs/applications/software to implement the method are variable and can be added or subtracted, be made required or optional, depending on the desired settings the senders or readers set such as but not limited to digital content, front-end setting such as color, privacy settings, and related functions and procedures. The printed card, once saved, can be shipped directly to other recipients or back to the sender with new or revised content.

Note that in composing a content of the reading material, the writer adds the digital information, writings, diagrams, photos, illustrations, and the like to the Central Server. The content is assigned with a unique ID that is stored on the material such as a greeting card via an NFC, QR code or printed ID to be mailed or handed over to the recipient. Once it is read by the recipient, the writer may or may not be notified, depending on the preferred option. The writer then may activate it for allowing it to be revised and resent. Depending on the option set by the writer or by the system default, it can also auto-allow after certain time or after certain events have been triggered such as but not limited to clicking, viewing of content, claiming the attached gift-card, reader signing up or logging in, just to name a few.

While the present invention has been described in terms of particular embodiments and applications, in both summarized and detailed forms, it is not intended that these descriptions in any way limit its scope to any such embodiments and applications, and it will be understood that many substitutions, changes and variations in the described embodiments, applications and details of the method and system illustrated herein and of their operation can be made by those skilled in the art without departing from the spirit of this invention.

### ABSTRACT OF THE DISCLOSURE

A system and method for the printed card such as greeting card, postcard, or business card to be reusable to the recipients of the said card so that it can be handed over to another recipient with the new or revised contents comprising of the printed card with embedded RFID (NFC), an application on the Central Server that manages the content, and the personal device that the writer or reader of the printed card use to connect to the Central Server to process desired action on the contents upon identifying the specific printed card via the NFC, QR code or Card ID embedded, printed or attached to the printed card.

1. The system and method of the reusable printed card comprises of a tangible printed card with embedded NFC device and/or QR code and Card ID, and a Central Server with the computer application and database capable of communicating via the internet, and a personal device the writer and the reader of the card should have such as smart phone, tablet, or laptop that is capable of connecting to the application system on the Central Server via the internet.

2. The reusable printed card of claim 1 has a front or forward cover with printed art or writings that communicates certain message such as greetings or information, depending on the purpose such as but no limited to as a greeting card, post card, business card, invitation, newsletter, brochure, and something similar.

3. The reusable printed card of claim 1 wherein it has an embedded Near Field Communication (NFC) device and/or a QR code and/or a Card ID formulated and assigned uniquely to the card, to identify the card by the Central Server application.

4. The system of claim 1 wherein the reusable printed card can have other specific message and/or information other than the printed art or writings, which is to be chosen or composed by the sender or the writer of the card, and is viewable as well as revisable to the reader of the card making the card reusable.

5. The system and method of claim 4 wherein the revisable contents composed or selected by the writer of the reusable printed card are stored in Central Server that can be retrieved by the reader upon tapping the printed card or by scanning the QR code in the card or entering the card ID in the application or browser in the reader's personal device that is communicating to the Central Server via a digital network such as the internet.

6. The system and method of claim 5 wherein the Central Server's application is configured to accept related request from the writer's or reader's personal device by passing the Card ID identified via the plurality of NFC device, QR code or manually entered ID embedded or indicated in the printed card.

7. The system and method of claim 6 wherein the application on the Central Server is configured to accept request to display choices to select options, compose, store, search, retrieve, delete, revise, post, publish, attach, download, upload and create history of the contents, digitally, as requested by the sender or writer of the printed card.

8. The system and method of claim 6 wherein the application on the Central Server is configured to accept request to display choices, compose, store, search, retrieve, delete, revise, post, publish, attach, claim, download, upload, and create history of the contents as requested by the reader or the recipient of the printed card.

9. The method of claim 7 wherein the sender or writer of the printed card can set attributes of the printed card such as but not limited to privacy setting, design, recipient's view and edit rights, posting and publish rights, date or duration to allow revision and resending of the printed card, revisions limit, geography limits, duplication rights, and the like as manages by the application in the Central Server.

10. The method of claim 8 wherein the reader or the recipient of the printed card can set new on some or all of the existing attributes of the printed card such as but not limited to privacy setting, design, recipient's view and edit rights, posting and publish rights, date or duration to allow revision and resending of the printed card, revisions limit, geography limits, duplication rights, and the like as manages by the application in the Central Server.

11. The method of claim 5 wherein the application in the Central Server identifies which content to process by receiving the Card ID sent via the internet using a personal device that accept the input via an NFC device or QR code or the written Card ID embedded or indicated on the printed card.

12. The application system and method of claim 1, wherein the sender or writer can order card from the ordering application system in the Central Server to either be mailed directly to the reader or recipient, or mailed to the sender or writer.

13. The application system and method of claim 12, wherein the sender or writer can compose the content of the card upon checking out the order of the printed card online, or wait for the printed card to arrive to compose the content in the same manner.

14. The application system and method of claim 12, wherein the sender or writer can choose a non-revisable portion design of the printed card by choosing a final design, or a customizable design, or create a new design using the design editor application in the Central Server that allows uploading of the whole design digitally or a portion thereof using a customizable design.

15. The application system and method of claim 12, wherein the sender or the writer can compose the content of the card upon ordering the printed card online and be sent individually or by batch to one or many recipients with the same or different addresses each with the same content or different contents.

16. The supplication system and method of claim 10, wherein the reader or recipient of the printed card can share the content via the social media, save the content in the Central server for memory-keeping, and/or download the content to save locally on the personal device.

17. The application system and method of claim 10, wherein the reader or recipient of the printed card can choose to save the sender's contact information on recipient's contact list application of the personal device if applicable, such as a smart phone, which when saved will include contact information such as but not limited to sender's name, address, phone numbers, photo and website.

18. The system and method of claim 6 wherein the application on the Central Server is configured to accept digital attachment of the content such as but not limited to images, videos, music, gifts, transactions, files, address links, and the like.

19. The application system and method of claim 12, wherein the sender or writer can have his/her own reusable printed card manufactured, wherein he/she will only need to order and affix an NFC chip sticker, or QR code, or Card ID that is generated by the Central Server so that his/her manufactured printed card can be viewed and revised by the reader or recipient of the printed card in the same manner. Whether the manufactured card is suitable to resending it or not is the discretion of the recipient of the card.
